(19) United States
(12) Patent Application Publication
(10) Pub. No.: US 2010/0046775 A1
(43) Pub. Date: Feb. 25, 2010

(54) METHOD FOR OPERATING A HEARING APPARATUS WITH DIRECTIONAL EFFECT AND AN ASSOCIATED HEARING APPARATUS

(76) Inventor: Andreas Tiefenau, Nürnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/553,260

(22) Filed: Sep. 3, 2009

Related U.S. Application Data
(60) Provisional application No. 61/095,326, filed on Sep. 9, 2008.

(30) Foreign Application Priority Data
May 9, 2008 (DE) 10 2008 046 040.0

(51) Int. Cl. H04R 25/00

(52) U.S. Cl. 381/313

(57) ABSTRACT

A method for operating a hearing apparatus and an associated hearing apparatus is provided. A first and a second microphone emit a first and a second microphone signal. The first and the second microphone have a different directional effect, for instance as a result of a different shading by the body of a hearing device wearer. A frequency analysis of the two microphone signals is performed. A determination of a frequency-dependent amplification for an output signal of the hearing apparatus from the two microphone signals transformed in the frequency range such that frequencies are amplified in a directionally-dependent fashion.

### CROSS REFERENCE TO RELATED APPLICATIONS

This application claims priority of German application No. 10 2008 046 040.0 filed Sep. 5, 2008, and the provisional patent application 61/095,326 filed on Sep. 9, 2008. All of the priority applications are incorporated by reference herein in their entirety.

### FIELD OF INVENTION

The invention relates to a method for operating a hearing apparatus comprising a first and a second omnidirectional microphone and an associated hearing apparatus specified with directional effect.

### BACKGROUND OF INVENTION

The speech behavior in an interference noise-filled environment is a frequently known problem of the hard-of-hearing, who require a high signal-to-noise ratio of up to 10 dB here in order to achieve the same speech intelligibility as a person with normal hearing. Moreover, the natural directional effect of the outer ear gets lost in the case of a supply with behind-the-ear hearing devices. The rehabilitation with hearing devices is therefore not only to include the individual compensation of the hearing loss by means of amplification and dynamic compression but instead also the reduction of interference noises in order to effect a significant improvement in the speech intelligibility in situations with interference noise. Modem digital hearing devices have interference noise suppression methods, which satisfy the hearing device-specific requirements in respect of efficiency, sound quality and artifact freedom.

Directional microphone systems rank here among the interference noise suppression methods established years ago and subsequently result in improving the speech intelligibility in hearing situations, in which the useful signal and the interference noise signals come from different directions. In modern hearing devices, the directional effect is generated by differentially processing two or more adjacent microphones with omnidirectional characteristics.

FIG. 1 shows a simplified block diagram of a directional microphone system of the 1^{st} order comprising two microphones 1, 2 at a distance of approximately 10 to 15 mm. As a result, an external delay of T2 is produced between the first and the second microphone, which corresponds to the distance of the microphones 1,2 in respect of one another, for sound signals which come from the front V. The signal R2 of the second microphone 2 is delayed by the time T1 in the delay unit 3, inverted in the inverter 4 and added with the signal R1 of the first microphone 1 in the first adder 5. The total produces a directional microphone signal RA, which can be fed to a receiver by way of a signal processing for instance. The directional-dependent sensitivity essentially consists of a subtraction of the second microphone signal R2 delayed by the time T2 from the first signal R1. Sound signals from the front V are therefore, depending on suitable distortion, not attenuated, while sound signals from the rear S are deleted for instance. The design and efficiency of directional microphone systems for hearing devices are described in the patent DE 103 31 956 B3.

The disadvantage of directional microphone systems is that in the case of high amplification these are unstable as a result of feedback. Generally the amplification can be selected to be greater when using omnidirectional microphones, thereby being advantageous particularly in the case of extreme hearing difficulties.

DE 102 49 416 A1 specifies a method for adjusting and operating a hearing aid device which can be worn on the body of a test person comprising a microphone system arranged outside the auditory canals of the test person when the hearing aid device is being worn.

DE 698 03 933 T2 specifies an arrangement and a method for embodying a predetermined amplification characteristic as a function of the direction, from which the acoustic signals are received. To this end, delays in acoustic signals are determined relative to one another.

DE 603 16 474 T2 also specifies a method and a microphone system for providing a directional response, with an output signal being minimized in terms of energy.

CH 693 759 A5 also specifies an apparatus and a method for suppressing interference noises, with an output signal being formed from two microphones by means of filtering and wiring.

### SUMMARY OF INVENTION

It is the object of the invention to specify a method for operating a hearing apparatus as well as a hearing apparatus, which enables a directional effect even when using omnidirectional microphone signals.

According to the invention, the set object is achieved with the method and the hearing apparatus of the independent claims.

The invention claims a method for operating a hearing apparatus comprising a first and a second microphone which can be shielded against certain directions. The microphones emit a first and/or a second microphone signal. The first and the second microphone indicate a different directional effect. The method includes the following steps:
a frequency analysis of the two microphone signals and
a determination of a frequency-dependent amplification for an output signal of the hearing apparatus from the two microphone signals transformed into the frequency range.

This is advantageous in that a higher stability of omnidirectional microphones is combined with a directionally-dependent signal processing.

In one development, the directional effect can be effected by shielding against ambient sound. As a result, a microphone directional effect can be generated without additional measures.

In a further embodiment, as a result of the different shielding from the first microphone, the ambient sound can be predominantly recorded from the front and from the second microphone the ambient sound can be predominantly recorded from the rear. This enables speech to be identified from the front during the signal processing for instance.

The method may also comprise the following steps:
generating the output signal from the first and/or second microphone signal and
an amplification of the output signal with the frequency-dependent amplification.

This is advantageous in that the omnidirectional signal is amplified in a frequency-dependent fashion as a function of the original direction of the processed signal.

The hearing apparatus can also include at least a third microphone emitting a third microphone signal. As a result, body microphones and hearing device microphones can be combined.

In one development, the method can include the following steps:
generating the output signal from the at least one third microphone signal and
an amplification of the output signal with the frequency-dependent amplification.

In one advantageous embodiment, the frequency-dependent amplification can be determined from a difference of the first and the second microphone signal. Sound from the front and sound from the rear can be separated in this way for instance.

The invention also specifies a hearing apparatus comprising a first and a second microphone emitting a first and a second microphone signal. The first and the second microphone have different directional effects. The two microphone signals can be transformed by a Fast Fourier Transformation or a filter bank into the frequency range and a frequency-dependent amplification can be determined for an output signal of the hearing apparatus from the two microphone signals transformed in the frequency range.

In one development, the directional effect can be achieved by shielding in respect of ambient sound.

In one further embodiment, as a result of the different shielding, the first microphone can receive the ambient sound predominantly from the front and the second microphone can receive the ambient sound predominantly from the rear.

The output signal can advantageously be formed from the first and/or the second microphone signal and the output signal can be amplified with the frequency-dependent amplification.

The hearing apparatus can also be embodied as a behind-the-ear hearing device, with the two microphones being arranged in the behind-the-ear hearing device.

In one further embodiment, the different shielding can be achieved by means of an outer ear shading.

In a preferred embodiment, the first and the second microphone can be embodied as body microphones and the hearing apparatus can include a hearing device with at least one third microphone emitting a third microphone signal.

The output signal can also be formed from the at least one third microphone signal and the output signal can be amplified with the frequency-dependent amplification.

The different shielding can be effected by the body of a hearing device wearer in one further embodiment.

In one development, the first and the second microphone can each include a radio transmitter facility, which transmits a frequency-dependent level information to the hearing device for determining the frequency-dependent amplification. Bandwidth-saving data can be transmitted as a result.

In one advantageous configuration, the first and the second microphone can be located in different hearing devices and the hearing devices can each include a radio transmitter facility, which transmits a frequency-dependent level information to the other hearing device in order to determine the frequency-dependent amplification. This is advantageous in that no additional body microphones are needed.

### BRIEF DESCRIPTION OF THE DRAWINGS

Further details and advantages of the invention are apparent from the subsequent explanations of several exemplary embodiments on the basis of schematic drawings, in which;

FIG. 1: shows a block diagram of a directional microphone according to the prior art,

FIG. 2: shows a hearing apparatus with a behind-the-ear hearing device,

FIG. 3: shows a hearing apparatus with body microphones,

FIG. 4: shows a block diagram of a hearing apparatus and

FIG. 5: shows a hearing apparatus with two behind-the-ear hearing devices.

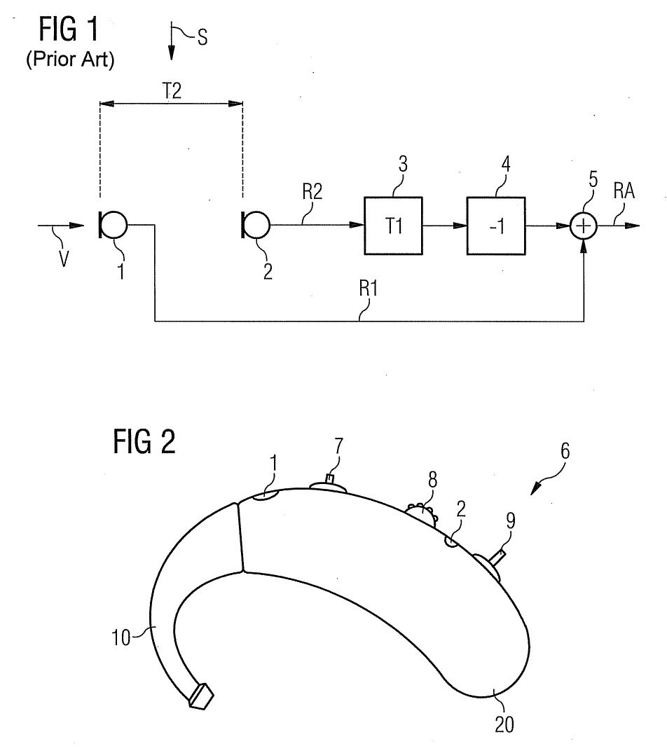

### DETAILED DESCRIPTION OF INVENTION

FIG. 2 shows a behind-the-ear hearing device 6 of an inventive hearing apparatus. The hearing device 6 includes an ear wearing hook 10 and a base unit 20. The base unit 20 includes an MTO switch 7 for switching off the hearing device 6 and for manually selecting the operating mode of the signal recording by way of an integrated microphone 1, 2 or a telephone coil (not shown), a volume controller 8 and a program selection key 9 for adjusting different hearing programs. Two microphones 1, 2 which are at a distance from one another, a first microphone 1 and a second microphone 2, receive an ambient sound essentially from different directions as a result of different shading by an outer ear of a hearing device user. The first microphone 1 preferably detects sound from the front, the second microphone 2 preferably detects sound from the rear. The signals of the two microphones 1, 2 are evaluated in a frequency-dependent fashion and are used for a frequency-dependent amplification of one or both microphone signals. For instance, it is possible to determine from the difference of the two microphone signals whether a sound signal to be amplified comes from the front or the rear. For frequency parts from the front, the signal routed to the receiver is amplified more accordingly.

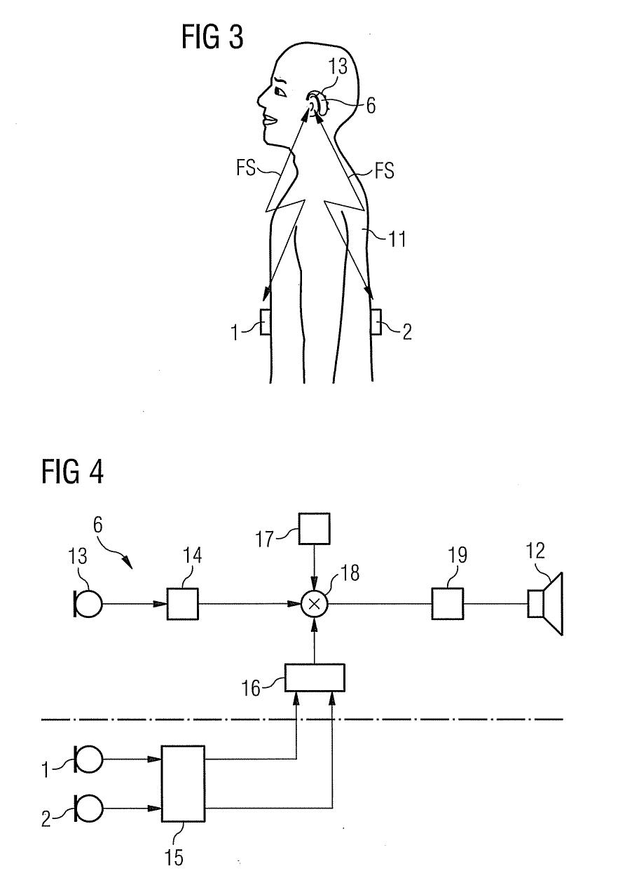

FIG. 3 shows an inventive embodiment with body microphones. A first microphone 1 is attached to the body 11 of a person, a second microphone 2 is attached to the back of the person. In this way the first microphone 1 preferably receives ambient sound from the front, while the second microphone 2 essentially receives ambient sound from the rear. A hearing device 6 with a third microphone is arranged behind the ear of the person. The two body microphones 1, 2 send frequency-dependent level information by radio waves FS to the hearing device 6, where the information for the determination of a frequency-dependent amplification of the microphone signal of the third microphone 13 is evaluated.

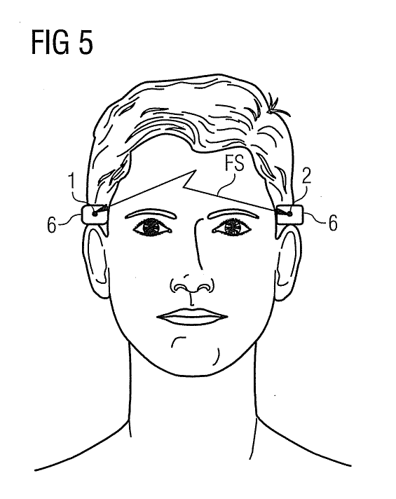

FIG. 4 shows a block diagram of the arrangement according to FIG. 3. The microphone signals reach a first filter bank 15 from the outputs of the two microphones 1, 2 with directional effect, in which filter bank a frequency analysis takes place. The frequency-dependent level information reaches an amplification determination unit 16 of the hearing device 6 from the outputs of the first filter bank 15. In the amplification determination unit 16, the level information of the first and second microphone 1, 2 is analyzed and evaluated and frequency-dependent amplification factors are determined. These are fed to an input of a multiplier 18.

The signal of the third microphone 13 of the hearing device 6 is broken down in a second filter bank into its frequency components and is fed to an additional input of the multiplier 18. A frequency-independent amplification factor reaches the multiplier 18 from a basic amplification unit 17, for instance volume controller, by way of an additional input of the multiplier 18. The signal of the third microphone 13 is now amplified in the multiplier 18 according to the amplification factor and the amplified signal is then fed to an inverse Fourier transformation. The output signal converted into the time region is fed to an input of a receiver 12. The electrical signals are converted there into acoustic signals. A sound signal with directional information is thus made available to a hearing device user.

Mathematically, the method proceeding in the apparatus according to FIG. 4 can be shown as follows:

The equations

S₁(t) [symbol] S₁(t,n) (1)

S₂(t) [symbol] S₂(t,n) (2)

S₃(t) [symbol] S₃(t,n) (3)

describe a breakdown of three microphone signals by means of a filter bank, for instance similarly to filtering in the hearing device, into several channels, indicated by the frequency parameter n.

The frequency-transformed first and second microphone signals are transformed into frequency-dependent level information (e.g. by means of low pass filtering):

L₁(t,n)=Level{S₁(t,n)} (4)

L₂(t,n)=Level{S₂(t,n)} (5)

A frequency-dependent amplification g( ) is determined from the thus determined level information, said amplification being multiplied together with a basic amplification gain ( ) with the third microphone signal S₃(t)

S_{A}(t,n)=S₃(t,n) [symbol] {gain(n)+g[L₁(t,n),L₂(t,n)]}. (6)

The output signal S_{A}(t) is then determined by recovery from the individual channel signals S_{A}(t,n).

$${S}_{A} ( t ) = {{\sum }_{n = 1}}^{m} {S}_{A} ( t , n ) . \qquad ( 7 )$$

In one configuration of the invention, the weighting of the frequency-dependent amplification can be matched to the long time spectrum of speech. Speech-relevant signal parts arriving from the front can as a result be more easily detected.

In a further embodiment, the use of additional, external microphones can be avoided. To this end, level information is exchanged between a left and a right hearing device. As a result, laterally arriving sound can be detected. In FIG. 5, a head of a hearing device user with two behind-the-ear hearing devices 6 is shown. At least one first microphone 1 is located in one of the two hearing devices 6, and a second microphone 2 is located in the other hearing device 6. The two microphones 1, 2 are differently shaded as a result of their arrangement in respect of the ambient sound. As described further above, the microphone signals are processed and the level information is transmitted to the respective other hearing device by radio signal FS for further processing. A directional effect can thus be generated in each hearing device 6.

1.-16. (canceled)

17. A method for operating a hearing apparatus, comprising:
providing a first microphone and a second microphone which emit a first and a second microphone signal and comprise different directional effect as a result of different shielding or shading in respect of ambient sound;
conducting a frequency analysis of the two microphone signals; and
determining a frequency-dependent amplification for an output signal of the hearing apparatus from the two microphone signals transformed in the frequency range such that frequencies are amplified in a directionally-dependent fashion.

18. The method as claimed in claim 17, wherein as a result of the different shielding, the first microphone predominantly receives the ambient sound from the front and the second microphone predominantly receives the ambient sound from the rear.

19. The method as claimed in claim 17, further comprises:
generating the output signal from the first and/or second microphone signal; and
amplifying the output signal with the frequency-dependent amplification.

20. The method as claimed in claim 17, wherein the hearing apparatus includes a third microphone emitting a third microphone signal.

21. The method as claimed in claim 20, further comprises:
generating an output signal from the third microphone signal; and
amplifying the output signal with the frequency-dependent amplification.

22. The method as claimed in claim 17, wherein the frequency-dependent amplification is determined from a difference of the first and second microphone signal.

23. A hearing apparatus, comprising:
a first microphone emitting a first microphone signal; and
a second microphone emitting a second microphone signal,
wherein the first and the second microphone comprise different directional effects as a result of different shielding or shading in respect of ambient sound,
wherein the first and second microphone signals are transformed by a Fast-Fourier-Transformation or a filter bank into the frequency range, and
wherein a frequency-dependent amplification for an output signal of the hearing apparatus is determined from the microphone signals transformed in the frequency range such that frequencies are amplified in a directionally-dependent fashion.

24. The hearing apparatus as claimed in claim 23, wherein as a result of the different shielding, the first microphone predominantly receives the ambient sound from the front and the second microphone predominantly receives the ambient sound from the rear.

25. The hearing apparatus as claimed in claim 23, wherein the output signal is formed from the first and/or second microphone signal and the output signal is amplified with the frequency-dependent amplification.

26. The hearing apparatus as claimed in claim 23, wherein the hearing apparatus is embodied as a behind-the-ear hearing device, with the two microphones being arranged in the behind-the-ear hearing device.

27. The hearing apparatus as claimed in claim 26, wherein the different shielding is achieved by an outer ear shading.

28. The hearing apparatus as claimed in claim 23,
wherein the first and the second microphone are embodied as body microphones, and
wherein the hearing apparatus includes a hearing device which comprises a third microphone emitting a third microphone signal.

29. The hearing apparatus as claimed in claim 28, wherein the output signal is formed from the at least one third microphone signal and the output signal can be amplified with the frequency-dependent amplification.

30. The hearing apparatus as claimed in claim 28, wherein the different shielding is effected by the body of a hearing device wearer.

31. The hearing apparatus as claimed in claim 28, wherein the first and the second microphone each have a radio transmitter facility, which transmits a frequency-dependent level information to the hearing device in order to determine the frequency-dependent amplification.

32. The hearing apparatus as claimed in claim 23, further comprises:
two hearing devices,
wherein the first microphone is a first of the two hearing devices and the second microphone is in a second of the hearing devices, and
wherein the first and second hearing devices each have a radio transmitter facility which transmits a frequency-dependent level information to the other hearing device in order to determine the frequency-dependent amplification.
